(19) United States
(12) Patent Application Publication
(10) Pub. No.: US 2010/0276056 A1
(43) Pub. Date: Nov. 4, 2010

(54) RADIATION THERAPY MASK TAPE AND RELATED METHOD

(76) Inventor: Maeghan E. Traboulsi, South Boston, MA (US)

Correspondence Address: MCCARTER & ENGLISH, LLP HARTFORD;CITYPLACE I, 185 ASYLUM STREET, HARTFORD, CT, 06103, US

(21) Appl. No.: 12/760,416

(22) Filed: Apr. 14, 2010

Related U.S. Application Data
(60) Provisional application No. 61/175,371, filed on May 4, 2009.

(51) Int. Cl. B31B 1/62; B32B 7/12

(52) U.S. Cl. 156/60; 428/343

(57) ABSTRACT

A flexible, durable, cushioning and/or resilient adhesive-backed tape for use with a radiation therapy mask for protecting a user from sharp or pointed curved edges defined thereby. The adhesive is capable of securing the tape to the edges of a radiation therapy mask for an extended period of time. The adhesive tape includes a resilient and/or compressive layer that defines an axially-extending, substantially solid central portion and at least one peripheral portion that defines a plurality of segments that extend from said central portion. The segments allow the tape to conformably attach to a curved edge of a mask and substantially cover and cushion the edge. A liner is removably adhered to the compressive layer for selectively exposing the adhesive and readying the tape for use.

This application claims the benefit under 35 U.S.C. §119(e) of co-pending U.S. provisional application No. 61/175,371, filed May 4, 2009, which is incorporated by reference in its entirety as part of the present application as if it were fully set forth herein.

### FIELD OF THE INVENTION

The present invention generally relates to the fields of adhesive tapes, and more particularly, to tapes that can be applied to sharp or ragged edges of material, such as the edges of masks used in radiation therapy, to protect persons from the sharp or ragged edges, and to methods relating thereto.

### BACKGROUND

Radiation therapy is a medical procedure used, for example, to treat cancerous tissues. Cancer treatment using radiation therapy is a common and growing method of treatment for patients with many kinds of cancers. To achieve the most successful radiation therapy treatment, it is important to have the radiation beam hit the cancerous tissue, while sparing as many healthy cells around the cancer as possible. Unfortunately, cancerous tissues almost always lie adjacent to healthy tissues that contain important organs, nerves or other structures that are sensitive to radiation injury. This circumstance is especially true with cancerous tissues located in the head or neck region of a patient. Therefore, in these circumstances, great care must be taken to spare normal tissue and only irradiate the cancerous tissues during the entire course of a radiation treatment.

Radiation therapy almost always entails multiple treatments given several days a week over several weeks. The patient must therefore be positioned and re-positioned accurately for each radiation therapy treatment to ensure that the proper radiation dose is delivered to diseased tissue and not to healthy tissue. To this end, a mask, typically made of plastic, such as a thereto-forming plastic, is commonly used to aid in immobilizing a patient with a cancer of the head or neck during treatment as well as repositioning the patient from treatment to treatment. The thermoplastic mask is made from a plastic mesh material that becomes soft and pliable when warmed and hard and stiff when cooled. In this way, a warmed thermoplastic mesh sheet can be placed over a patient's head and neck region and molded to the contours of the patient's anatomy. As the mask cools, a rigid replication of the patient's anatomy is created. This mask is then stored and used for each of the patient's radiation therapy treatments.

In some cases, there is a need to cut the mask once it is cooled and hardened. For example, claustrophobic patients appreciate cutouts corresponding to the patient's eyes, mouth and nose and/or nostrils. As another example, patients requiring a bite block require an aperture in the mask corresponding to the patient's mouth. In other cases, areas of the mask are simply removed because they have become too tight or otherwise irritate the patient. When cut, the mesh pattern of the thermoplastic mask tends to leave hard, sharp, pointed edges or points which can be uncomfortable and even scratch or cut the patient.

To protect the patient from these sharp edges and points and/or to make the thermoplastic mask more comfortable, adhesive tapes are commonly used to cover or otherwise screen the edges or points of the mask. Typically, masking, duct, Scotch® brand tape and other silk, paper or cloth tapes have been utilized because these types of tapes are commonly found in doctor's offices, hospitals and other places where thermoplastic masks are used. However, these types of tapes have achieved only limited success. Because the apertures cut in the masks arc defined by relatively small radiuses, prior art tapes must be arduously cut into small lengths and pieced together around the curved edges until all desired areas are covered. Another drawback of prior art tapes is that they allow rough edges and/or points of the mask to poke through the tape because they are thin and/or not cushioned. Thin, non-cushioned tapes require typically several layers to be painstakingly applied to the mask to protect the patient from the sharp edges. Yet another drawback of prior art tapes is that they do not adhere or secure themselves well to plastic masks. The prior art tapes tend to fall off as they lose adhesion over time during the treatment period and thus frequently need to be re-applied. This practice can be dangerous as the tapes are also typically marked and used to mark treatment planning reference points.

Accordingly, it is an object of the present invention to overcome one or more of the above-described drawbacks and/or disadvantages of the prior art.

### SUMMARY OF THE INVENTION

In accordance with a first aspect, the present invention is directed to a tape to be applied to a sharp, pointed or ragged curved edge of a mask for use in radiation therapy treatment. The tape is preferably flexible and compressible, and remains over the edge of the mask for the entire radiation treatment period. The adhesive tape protects the user from the sharp, pointed or ragged curved edge of the mask.

In accordance with another aspect, the tape comprises a longitudinally-extending compressive layer defining (i) an edge covering portion that extends axially along the length of the compressive layer and laterally between opposing marginal portions thereof, and is conformably attachable to the edge of the mask to substantially cover the edge. A plurality of laterally-extending apertures are formed in at least one, and preferably both, marginal portions of the compressive layer. The laterally-extending apertures are axially spaced relative to each other and define laterally-extending segments therebetween that are adhesively attachable to a marginal portion of the mask defining the edge for adhesively attaching the tape to the mask.

In a currently preferred embodiment of the present invention, the tape comprises a top layer and an adhesive layer affixed to one side of the top layer. The top layer is formed of a flexible, cushioning foam material. The foam layer defines (i) an exterior surface for contacting a user and providing a durable marking surface, (ii) an interior surface opposing the exterior surface for covering an edge of the radiation therapy mask and any sharp edges or points defined thereby, and (iii) a plurality of slits extending through the thickness of the foam layer that are axially spaced on opposite sides of the foam layer relative to each other, extend inwardly from each side edge of the foam layer, and terminate before convergence at an approximately central, axially-extending solid portion of the foam layer. In preferred embodiments, adjacent slits allow the material defining the slits to separate or divide into segments and thereby allow the tape to fold over and conformably attach to a curved edge of a mask. In some embodiments, the foam layer defines a thickness within the range of about 1/64 inch to about 1/16 inch, and preferably about 1/32 inch thick, and a width within the range of about ½ inch to about 1½ inch, and preferably about 1 inch.

In some such embodiments, the slits extend substantially perpendicularly from each side edge, respectively. In some embodiments, the slits define a length from about ⅕ inch to about ⅘ inch, and preferably about ⅖ inch. Similarly, in some such embodiments, the opposing slits are aligned with each other, and each slit terminates from about 1/10 inch to about ⅖ inch, and preferably about ⅕ inch, from the corresponding slit that extends from the opposite side of the tape. In some embodiments, the slits are spaced from about 3/20 inch to about ⅗ inch from each other on each respective side, and preferably are spaced about 3/10 inch from each other.

In some embodiments of the present invention, the adhesive layer spans across the slits and prevents the material defining the slits from separating or dividing into segments until a predetermined force is applied across the slits to break the adhesive underlying the respective slits. In some embodiments, the adhesive layer comprises one or more hypoallergenic, latex-free adhesives capable of securing the tape to surfaces of a radiation therapy mask, such as a thermoplastic radiation therapy mask, for an extended period of time.

In accordance with another aspect, the present invention is directed to an adhesive tape including a resilient and/or compressive layer defining a plurality of slits axially spaced relative to each other and forming laterally extending attachment segments therebetween, an adhesive layer underlying the resilient layer and a releasable liner mounted to the adhesive layer that can be removed prior to installing the adhesive tape. The liner comprises a paper material with a silicone treatment applied thereon. In some embodiments, the liner defines a width greater than that of the resilient layer, and the liner extends past each side of the resilient layer. In some embodiments, the liner defines a width of about 2 inches, and the resilient layer defines a width of about 1 inch. In some such embodiments, the liner is manually engageable and removable prior to attaching the adhesive tape to the edge of a mask. In some embodiments, the resilient layer is a foam layer.

In accordance with another aspect, the present invention is directed to an adhesive tape for attachment to a sharp or ragged curved edge of a material, such as a plastic radiation therapy mask, to prevent injury from the edge. The tape comprises a cushioning foam or other type of resilient layer defining a series of corresponding slits that extend through the thickness and inwardly from each side edge of the layer, respectively, and terminate before convergence at a substantially solid, axially-extending region of the layer. The tape also includes an adhesive layer applied to an underside of the resilient layer capable of attaching the resilient layer to a sharp or ragged curved edge of the material. The adjacent slits define segments of the resilient layer and the segments separate from one another at the slits when the tape is applied to one side of the edge, the edge, and the opposing side of the edge.

In accordance with another aspect, the present invention is directed to an adhesive tape for attachment to a mask to cover an edge of the mask. The tape comprises first means for substantially conformably covering the edge of the mask and providing a compressive surface to the edge. A plurality of second means extend laterally from the first means and are separable from each other for engaging at least one surface of the mask that is adjacent to the edge. The tape further includes third means for adhering at least one of the first and second means to the mask. In one currently preferred embodiment, the first means is an axially-extending edge covering portion of a compressive tape, each second means is a laterally extending segment formed between axially-spaced, laterally-extending apertures formed in a marginal portion of the tape, and the third means is an adhesive layer of the tape. In some embodiments, the adhesive tape further comprises fourth means for releasably covering the third means. In some such embodiments, the fourth means is a release liner.

In accordance with another aspect, the present invention is directed to a method comprising the following steps: (i) substantially conformably covering an edge of a radiation therapy mask with an axially-extending, compressive edge covering portion of an adhesive-backed tape to cushion the edge and prevent the edge from harming a person using the mask; and (ii) adhering a plurality of laterally-extending segments formed in at least one marginal portion of the adhesive-backed tape to at least one surface of the mask that is adjacent to the edge to substantially conformably attach the tape to the mask substantially throughout a respective radiation therapy treatment period.

In some embodiments of the present invention, the method further comprises the step of writing at least one marking on an exposed surface of the tape in connection with the radiation therapy treatment.

In some embodiments of the present invention, the method further includes folding a plurality of laterally-extending segments onto the surface of the mask adjacent to the edge, and during the step of folding pivoting adjacent laterally-extending segments (i) away from each other and/or (ii) into an overlapping relationship, to conformably attach the edge covering portion of the tape to the edge of the mask.

One advantage of the adhesive tape of the present invention is that it easily conforms to curvatures to allow for large piece applications, such as around the curved edges of a radiation therapy mask. Another advantage of the adhesive tape of the present invention is that it effectively covers and cushions sharp, ragged or pointed curved edges common to such masks or like structures. Yet another advantage of the adhesive tape of the present invention is that it can maintain itself adhesively and conformably attach to a radiation therapy mask throughout the time period and multiple usages of the mask during an entire radiation therapy treatment period. A further advantage of the currently preferred embodiments of the adhesive tape of the present invention is that they feature a durable marking surface for marking crosshairs, field borders, leveling lines, shielding marks and the like that remains affixed to a radiation therapy, such as a thermoplastic mask, for the duration of an entire radiation therapy treatment period.

These and other advantages of the present invention, and/or of the currently preferred embodiments thereof, will become more readily apparent in view of the following detailed description and the accompanying drawings.

### BRIEF DESCRIPTION OF THE DRAWINGS

FIG. 1 is a top plan view of a currently preferred embodiment of an adhesive tape of the present invention;

FIG. 2 is bottom plan view of the adhesive tape of FIG. 1 with parts of the releasable liner and adhesive layer removed for clarity;

FIG. 3 is a cross-sectional view taken along the line 3-3 of FIG. 1;

FIG. 4 is a cross-sectional view taken along the line 4-4 of FIG. 1;

FIG. 5 is a cross-sectional view taken along the line 5-5 of FIG. 1;

FIG. 6 is side elevation view of the adhesive tape of FIG. 1 applied to a curved edge of a thermoplastic mask;

FIG. 7 is a cross-sectional view taken along the line 7-7 of FIG. 6;

FIG. 8 is a cross-sectional view taken along the line 8-8 of FIG. 6;

FIG. 9 is a perspective view of the adhesive tape of FIG. 1 applied to a thermoplastic mask;

FIG. 10 is a top plan view of an alternative embodiment of an adhesive tape of the present invention including a woven, vinyl filled fabric layer underlying a foam layer;

FIG. 11 is bottom plan view of the adhesive tape of FIG. 10 with parts of the releasable liner, adhesive layer and fabric layer removed for clarity;

FIG. 12 is a cross-sectional view taken along the line 12-12 of FIG. 10; and

FIG. 13 is a cross-sectional view taken along the line 13-13 of FIG. 10.

### DETAILED DESCRIPTION OF PREFERRED EMBODIMENTS

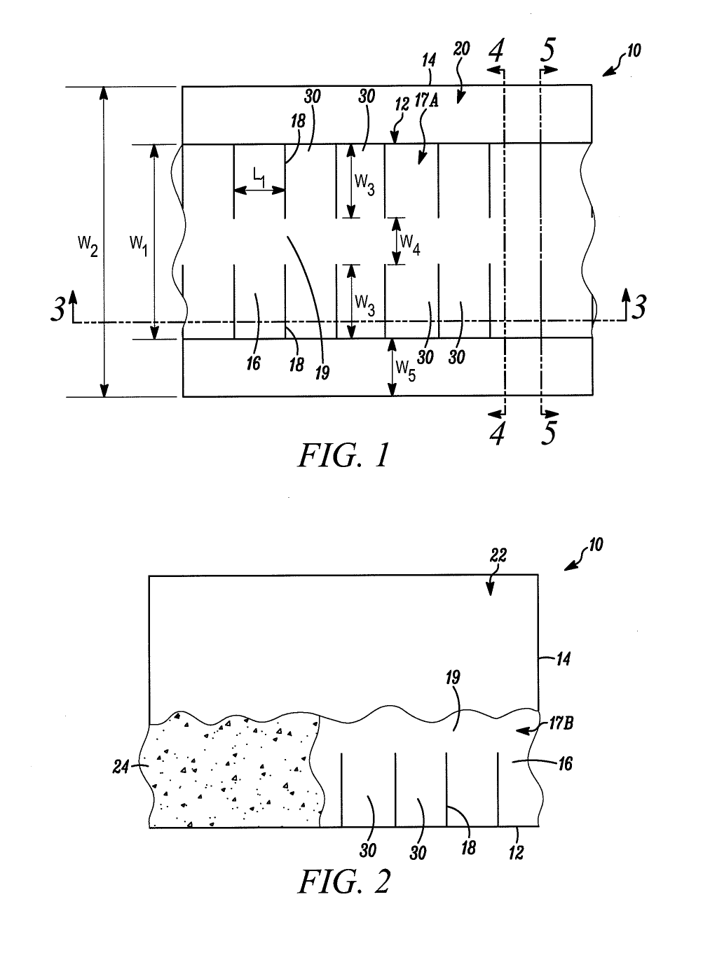

In FIGS. 1 through 5, an adhesive tape assembly embodying the present invention is indicated generally by the reference numeral 10. As shown in FIGS. 1 and 2, the adhesive tape assembly 10 comprises an adhesive tape 12 and a liner 14. The adhesive tape 12 comprises a compressive or resilient layer 16 that defines a top surface 17A and a bottom surface 17B, and an adhesive layer 24 underlying the resilient layer. The adhesive layer 24 is fixedly secured to the bottom surface 17B of the resilient layer 16. In regards to the adhesive tape assembly 10, the liner 14 is removably affixed to the adhesive layer 24. The resilient layer 16 defines a plurality of laterally extending apertures or slits 18 that are axially spaced relative to each other along the length of the resilient layer to define laterally extending segments 30 between adjacent slits 18 that extend from an axially-extending substantially solid portion 19 in the central region of the resilient layer. As described further below, the axially-extending central region 19 is adhesively attached to a curved or ragged edge of a radiation therapy mask to cushion the edge, and the laterally extending segments 30 adhesively attach the tape to the peripheral on other surfaces of the mask adjacent to the edge. As shown in FIG. 2, the slits or cuts 18 are unique to the foam material 16, i.e., the slits or cuts 18 extend from the top surface 17A to the bottom surface 17A of the foam material 16 and are not present in the adhesive layer 24. In use, and as described further below, a user removes the adhesive tape 12 from the liner 14, and applies the adhesive tape 12 over an edge of a thermoplastic mask before a radiation therapy treatment begins.

In the illustrated embodiment, the resilient layer 16 is formed of a foam or other resilient material selected to be compressible in response to any compressive forces applied thereto during a radiation therapy treatment, and to create a durable yet relatively soft, smooth external surface. The material forming the resilient layer 16 is also sufficiently durable and compressible so that it effectively covers, cushions and prevents sharp, ragged edges of masks from penetrating through the adhesive tape 12. The top surface 17A of the resilient layer 16 is selected to provide a durable marking surface for treatment planning marks and the like when applied to a radiation therapy mask.

In the illustrated embodiment, the soft, smooth top surface 17A provides a familiar feel to patients who are accustomed to the sensation of clothing or like materials, and also protects against the difference in temperature between the mask and the patient's skin. The resilient layer 16 also has a minimal effect on the surface dose of radiation, i.e., the tape 12 has a low density and absorbs little radiation such that the incremental change (reduction) in surface dose relative to the effect of the thermoplastic mask is not considered clinically significant in most foreseeable situations.

Although the resilient layer 16 may be formed from a variety of different materials and/or composites that are currently known or that later become known, the material used to form this layer is preferably “patient friendly” such that it is made from materials that are safe for use with patients and will not irritate a user. In a currently preferred embodiment, the resilient layer 16 is formed of a foamed thermoplastic polymer, such as a polyvinyl chloride (PVC) foam, which is comfortable to the touch of a user. In one preferred embodiment, the foam material 16 is a closed cell, polyvinyl chloride foam. A suitable PVC foam which may be used as the resilient layer 16 is sold by the 3M Company, such as the 3M™ 1/32 inch Medical PVC Foam Tape 9777-L. However, any of numerous materials that are currently known, or that later become known, including such materials that are flexible, durable, compressible and soft to the touch, equally may be employed.

As described above, the resilient layer 16 should be compressible when subjected to compression forces encountered during radiation treatment procedures, such as when the adhesive tape 12 is applied to a radiation therapy mask and a user's body contacts the top surface 17A of the resilient layer 16. Accordingly, the resilient layer 16 is thick enough to provide cushioning to the patient and/or to insulate the patient from the cold feel of the radiation therapy mask, but is thin enough so as to not interfere with the fit of the mask on the user. Preferably, the resilient layer 16 defines a thickness T1 within the range of about 1/64 inch to about ⅛ inch, and more preferably within the range of about 1/48 inch to about 1/16 inch. In the illustrated embodiment shown in FIGS. 1-5, the thickness T1 of the resilient layer 16 is about 1/32 inch thick. The resilient layer 16 should also be of a sufficient width W1 and length to substantially cover the edges of a mask, such as the sharp and/or pointed edges produced when an aperture or void is created in the mask. Accordingly, the resilient layer 16 is sufficiently wide and long enough to substantially cover and cushion such an edge and extend along the respective sides of a mask to secure the adhesive tape 12 to the mask. Preferably, the resilient layer 16 defines a width W1 within the range of about ½ inch to about 1½ inch. In the illustrated embodiment shown in FIGS. 1-5, the width W1 of the resilient layer 16 is about 1 inch wide. The length of the resilient layer 16 needs only to be long enough to substantially cover the edges of a mask. However, the resilient layer 16 may be provided in a length much longer than the required length for a particular application so that that a user can customize the length for the particular application, such as by cutting or ripping the resilient layer 16 into segments, and have enough material for multiple applications. In One embodiment, the length of the resilient layer 16 is about 310 cm. As may be recognized by those of ordinary skill in the pertinent art based on the teachings herein, these materials and dimensions are only exemplary, and numerous other materials, having any of numerous dimensions that are currently known, or that later become known, may be employed.

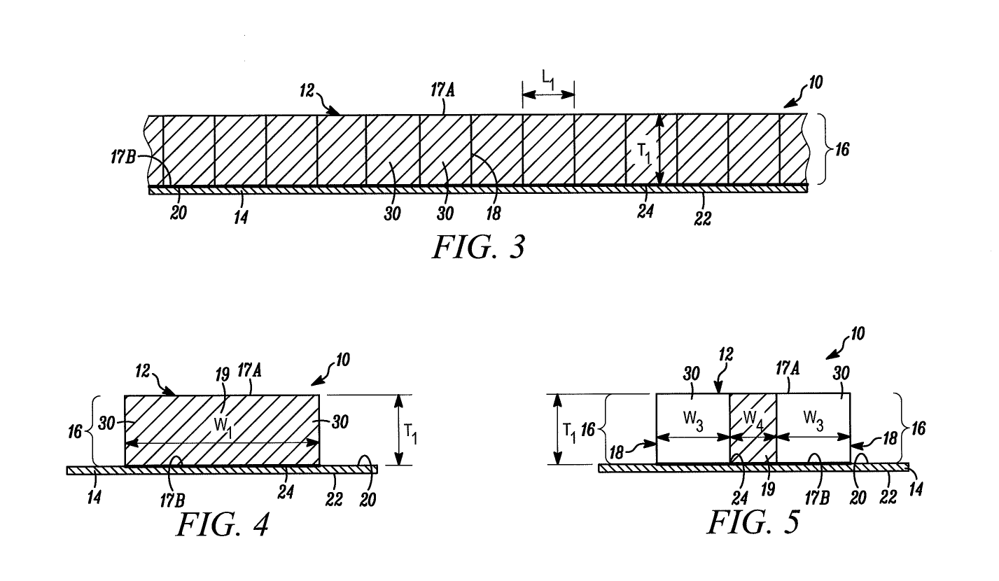

As is shown in FIGS. 1-5, in a currently preferred embodiment of the present invention, the resilient layer 16 defines a series of slits 18 that are axially spaced relative to each other and extend inwardly from each side edge of the resilient layer 16 and terminate before convergence with the opposing slit 18. As best shown by FIGS. 3 and 5, the slits 18 extend through the entire thickness of the resilient layer 16—i.e., they extend from the top surface 17A to the bottom surface 17B of the resilient layer 16. In the illustrated embodiment, the slits 18 extend substantially perpendicularly from each side edge of the resilient layer 16, respectively, toward the center of the resilient layer 16.

The slits 18 should be of a width W3 such that the axially-extending central area 19 of the resilient layer 16 is of a sufficient width W4 to at least substantially cover the edges of a radiation therapy mask and provide enough material so the tape 12 does not rip or tear too easily. Accordingly, the axially-extending central portion 19 of the resilient layer 16 is of a width W4 adequate to at least substantially cover the edge(s) of a radiation therapy mask and provide stability to the adhesive tape 12. Preferably, the axially-extending central region 19 of the resilient layer 16 located between opposing pairs of slits 18 is of a width W4 within the range of about 1/10 inch to about ⅖ inch. In the illustrated embodiment shown in FIGS. 1-5, the width W4 of the axially-extending central portion 19 between opposing pairs of slits 18 is about ⅕ inch.

In a currently preferred embodiment, the slits 18 are defined throughout the length of the resilient layer 16 (i.e., the opposing pairs of slits 18 are axially spaced relative to each other along the length of the tape). The slits 18 allow the material defining the slits 18 to separate or divide into laterally-extending segments. Thus, the foam material located between a pair of adjacent slits 18 can be characterized as a segment 30. The slits 18 (and therefore the segments 30) allow the resilient layer 16 to be folded over a curved edge of a radiation therapy mask and allow the adhesive tape 12 to conformably attach thereto. If the curved edge of the radiation therapy mask is concave (i.e., a surface that curves inwardly, such as the inside edge an elliptical aperture), the slits 18 allow the segments 30 to separate from one another to form substantially V-shaped openings between adjacent segments 30 and thereby allow the adhesive tape 12 to conformably attach to the curved mask edge. If, on the other hand, the curved edge of the mask is convex (i.e., a surface that bulges or extends outwardly, such as the outside edge of an ellipse), the slits 18 allow the segments 30 to overlap one another and thereby allow the adhesive tape 12 to conformably attach to the curve and at least substantially cover the edge throughout the curve. Thus, the greater the width W3 of the slits 18 and the segments 30, the greater the distance that the edges of the segments 30 will separate from one another, or overlap one another, in use. Similarly, the greater the number of slits 18 and the segments 30 per a pre-defined length of the resilient layer 16, the greater the ability of the adhesive tape to conformably attach to a curved edge. Accordingly, the slits 18 and the segments 30 should be of a width W3 capable of substantially completely covering and cushioning sharp or pointed edges of a radiation therapy mask, and be able to provide enough adhesive 24 surface area to securely adhere to the edges and the corresponding sides of the mask. Similarly, the length L1 of the segments 30 (and thus the distance between adjacent slits 18) should be such that the tape 12 can be conformably attached to curved edges that are typically found on a thermoplastic or other type of radiation therapy mask. Preferably, the width W3 of the segments 30 and the slits 18 are within the range of about ⅕ inch to about ⅘ inch. In the illustrated embodiment shown in FIGS. 1-5, the width W3 of the segments 30 and the slits 18 is about ⅖ inch wide. Preferably, adjacent slits 18 are spaced from one another (and thus the length of the segments 30) by a distance L1 within the range of about 3/20 inch to about ⅗ inch. In the illustrated embodiment shown in FIGS. 1-5, adjacent slits 18 are spaced from one another (and thus the length of the segments 30) by a distance L1 of about 3/10 inch.

As described above, in the illustrated embodiment an adhesive layer 24 is secured to the resilient layer 16 to form the adhesive tape 12. The adhesive 24 is fixedly secured to the bottom surface 17B of the resilient layer 16. Because the adhesive 24 may come into contact with users and/or individuals applying the adhesive tape 12 to radiation therapy masks, it is preferred that the adhesive 24 be a hypoallergenic, latex-free adhesive. Further, it is preferred that the adhesive 14 be a pressure sensitive adhesive such that it forms a bond when pressure is applied to marry the foam or other resilient material with an adhered (e.g., a radiation therapy mask). A pressure sensitive adhesive is preferred so that a solvent, water, and/or heat is not needed to activate the adhesive tape 12. It is also preferred that the adhesive 24 be of a sufficient strength to secure the adhesive tape 12 to a radiation therapy mask for the duration of a radiation treatment period—potentially up to several months. As can be best seen from FIG. 2, the adhesive layer 24 is fixedly secured over the entire bottom surface 17B of the foam layer 14, including over the slits 18. As such, the adhesive layer 24 acts to prevent the segments 30 from separating from one another until the strength of the adhesive 24 is overcome. Accordingly, it is preferred that the strength of the adhesive 24 be sufficiently high to prevent the separation of the segments 30 when the tape 12 is handled or applied to flat or straight surfaces, but not too high to prevent the segments 30 from separating when the adhesive tape 12 is applied to a curved edge of a radiation therapy mask—especially a curved edge that requires the segments 30 to separate in order to substantially conformably attach to the curved edge.

The adhesive layer 24 is also effective in affixing a release liner 14 to the tape 12. The liner 14 is releasably affixed to the adhesive layer 24 to protect the adhesive layer 24 prior to use—i.e., prevent the tape 12 from adhering to itself and to provide a quick and easy way to store, package and then expose the adhesive layer 24. In one currently preferred embodiment, the liner 24 is a paper material with a silicone treatment applied to at least the surface 20 that contacts the adhesive layer 24. The bottom or opposite surface 22 in respect to the contact surface 20, also may be treated with a silicone product. An overhang between the liner 14 and the adhesive tape 12 provides for easy liner starting and removal. Accordingly, as shown in the illustrated embodiment, the width W2 of the liner 14 extends substantially beyond the width W I of the foam layer 12 a certain distance W5. Further, as best shown in FIGS. 1 and 5, the width W2 of the liner 14 is substantially greater than the width W1 of the adhesive tape 12, and the adhesive tape 12 is centered on the liner 14. Preferably, the width W2 of the liner 24 is greater than the width W1 of the adhesive tape 12 by at least about 20%. Therefore, in an embodiment where the width W1 of the adhesive tape 12 is 1 inch, the width W2 of the liner 24 is at least about 1⅕ inch. In the illustrated embodiment shown in FIGS. 1-5, the adhesive tape 12 is centered on the liner 14, the width W2 of the adhesive tape 12 is about 1 inch and the width W2 of the liner 14 is about 2 inches (therefore the width W5 of the overhang of the liner 14 is about ½ inch on each side of the tape 12).

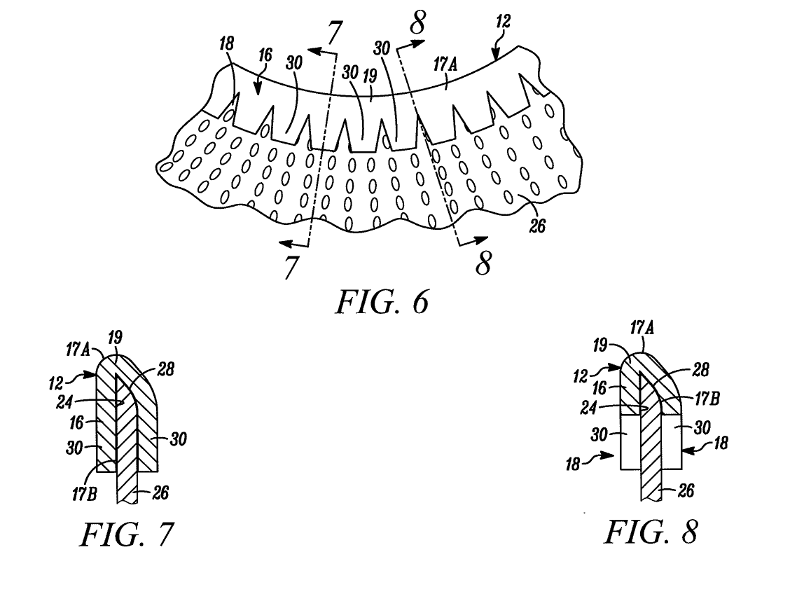

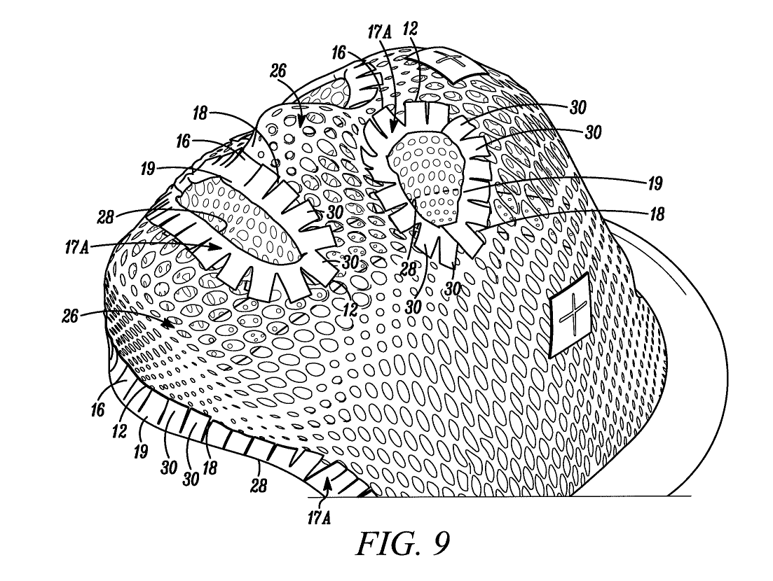

As shown in FIGS. 6-8, in the preferred use of the adhesive tape 12, a user obtains a length of the adhesive tape 12 and removes the liner 14 from the adhesive layer 24. A user then places the adhesive layer 24 on the edge of a radiation therapy mask 26 such that the top surface 17A of the resilient layer 16 is the exposed surface of the tape 12. The axially-extending central portion 19 of the tape 12 should be located approximately over the sharp, pointed edge 28 of the mask 26 with the opposing laterally-extending segments 30 folded onto the opposing sides of the respective mask edge 28 to conformably adhere the tape 12 to the edge 28. In order to conformably attach the tape 12 to the sharp, curved edge 28 of the mask 26, the strength of the adhesive layer 24 is overcome and the segments 30 are separated from one another. Because the radius of the curved edge of the mask 26 is less than the radius of the curved edge created by the edges of the tape 12, the segments 30 are spaced farther apart from one another towards the edges of the tape 12 as compared to the area adjacent to the central portion 19 of the tape 12—thus the slits 18 become approximately “V” shaped. As shown best by FIGS. 7 and 8, the. axially-extending central area 19 of the bottom surface 17B of the foam layer 16 abuts a sharp edge or point 28 of the mask 26 and the segments 30 extend down the opposing sides of the mask 26. In this way, the adhesive tape 12 conformably attaches to the curvature of the sharp edge 28 and cushions and protects a user from the sharp edge 28 of the mask 26. The adhesive tape 12 is thus securely affixed to the mask 26 for an extended period of time.

In some embodiments of the present invention, a plurality of adhesive tape assemblies 10 are packaged in a box that maintains the adhesive tape assemblies 10 in a sanitary condition, and allows the adhesive tape assemblies 10 to be readily dispensed therefrom for use. For example, the box containing the plurality of adhesive tape assemblies 10 may define a top panel that can be opened to remove the adhesive tape assemblies 10, and closed to retain the remaining adhesive tape assemblies 10 therein in a sanitary condition. As another example, a length of adhesive tape assembly 10 may be rolled, wound or otherwise provided in a dispenser capable of dispensing the adhesive tape assembly 10. The dispenser may provide a cutting surface or otherwise provide means to segment the adhesive tape assembly 10 according to a specific need or application. In other embodiments, the adhesive tape assembly 10 is provided in a respective sterile package, such as a paper or polymeric envelope, that seals the adhesive tape assembly 10 from the ambient atmosphere and maintains the sterility of the adhesive tape assembly 10 until ready for use. In order to use the adhesive tape assembly 10, the sterile package is torn or otherwise opened to remove the adhesive tape assembly 10 therefrom, the liner 12 is removed and the adhesive tape 12 is applied to a sharp or pointed edge 28 of a thermoplastic mask 26.

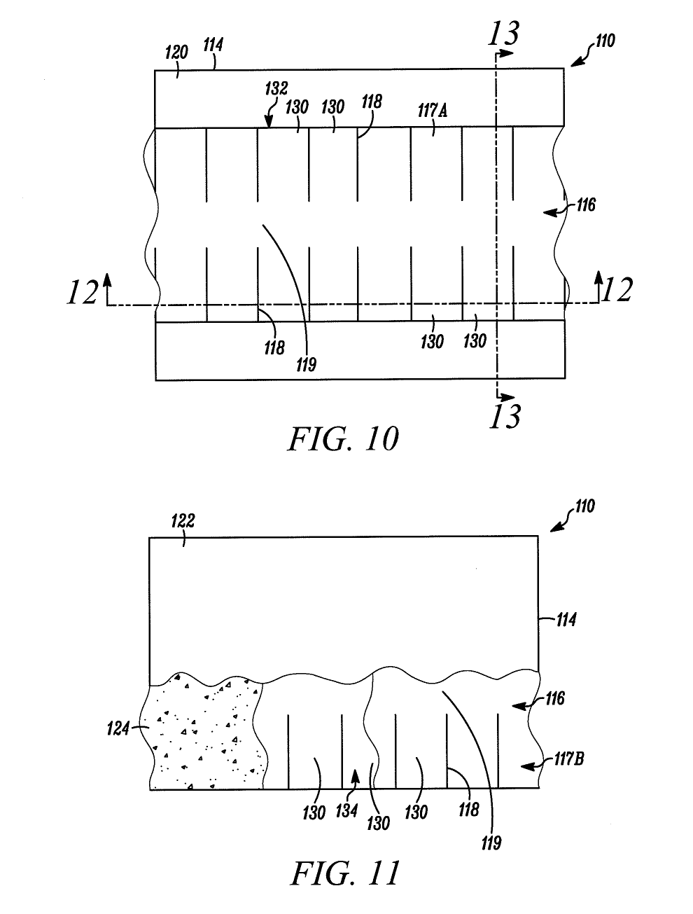

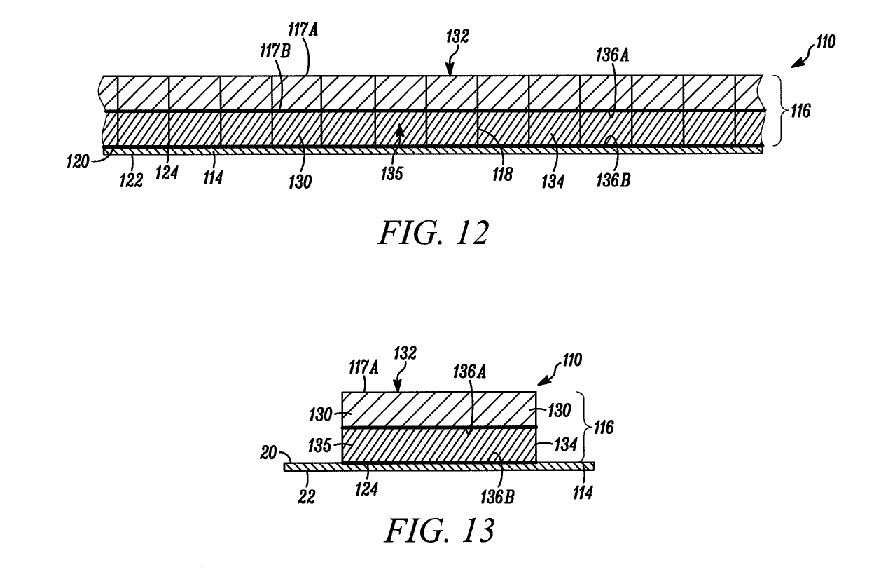

Referring now to FIGS. 10-13, an adhesive tape according to another embodiment of the present invention is indicated generally by the reference numeral 110. The adhesive tape 110 can be applied over an edge of a radiation therapy mask and is substantially similar to the adhesive tape 10 described above, and therefore like reference numerals preceded by the numeral “1”, are used to indicate like elements. The primary difference of the adhesive tape 110 in comparison to adhesive tape 10 is that the resilient layer 116 is a laminate comprised of two layers bonded together. The bottom layer is a vinyl filled, woven fabric layer 134 that defines a top surface 136A and a bottom surface 136B. The woven fabric layer 134 is filled with a vinyl material 135. The woven fabric layer 134 is durable and prevents the edges of a mask or like structure from poking through the adhesive tape 112 and injuring or irritating the user. The top layer is a soft, vinyl foam 116 which provides cushioning and is comfortable against the user's skin. The top vinyl foam layer 116 and the woven, vinyl filled fabric layer 134 define slits 118 that pass through the entire thickness of the filled, woven layer 134 and the foam layer 116. Adjacent slits 118 define segments 130 that can separate from one another and allow the tape 110 to conformably attach and substantially cover sharp, curved edges of a radiation therapy mask or like structure. As may be recognized by those of ordinary skill in the pertinent art based on the teachings herein, the layers of the laminated resilient layer 116 can be formed of any of numerous different materials, to exhibit any of numerous different properties and performing the function of tapes that are currently known, or that later become known. In addition, such laminated layers may include any desired number of layers of any such materials.

It may be readily understood by those having skill in the pertinent art from the present disclosure that any of numerous changes and modifications may be made to the above-described and other embodiments of the present invention without departing from the scope of the invention as defined in the appended claims. For example, the adhesive tape may be made of any of numerous different materials, in any of numerous shapes, taking any of numerous different dimensions. As another example, the tape may include additional layers, such as layers that provide or provide for markings, color, scent, cushioning, comfort, adhesion, durability. stability and/or flexibility. Also, the tape may be may be used in any of numerous different applications, including medical, industrial and domestic applications. In addition, the tape may be attachable to a radiation therapy mask or other structure in any of numerous different ways that are currently known, or that later become known. For example, rather than use conventional adhesives as described above, the adhesive may be defined by the underlying surface of the adhesive tape being formed of a soft, rubber or rubber-like surface, that forms a relatively high friction or sticky interface with the thermoplastic mask to prevent relative movement of the adhesive tape and mask. As another example, the slits may not be limited to the adhesive layer and may instead extend through the adhesive layer and/or the liner. Further, the opposing pairs of slits may not be aligned across the width of the tape, need not define the same widths, nor extend perpendicularly in respect to the side edges of the tape. For example, the slits may be off-set from one another along the length of the tape or may define varying lengths. Similarly, the opposing marginal portions of the tape need not define the same number of slits, slits of the shapes and/or slits of the same dimensions. Alternatively, one marginal portion of the tape need not define any slits at all. As another example, the design of the slits may vary from one another along the length of the tape. As another example, the slits may be curved, set at angles relative to the sides of the tape, and/or be any other size or shape sufficient to define gaps in the marginal portion(s) of the tape. As yet another example, the slits may take the form of perforations, scores or any other form sufficient to make the tape fragile at a predefined location so that the tape may be separated at such location. Still further, the tape may define at least one pre-cut or pre-determined length designed to suit a particular application, such as the edges of particular types of apertures in radiation therapy masks (e.g., eye, nose, mouth, etc.). Accordingly, this detailed description of the currently preferred embodiments of the present invention is to be taken in an illustrative, as opposed to a limiting sense.

What is claimed is:

1. A tape for attachment to a mask to cover an edge of the mask, comprising:
a longitudinally-extending compressive layer defining (i) an edge covering portion that extends axially along the length of the compressive layer and laterally between opposing marginal portions thereof, and is conformably attachable to the edge of the mask to cover the edge, and (ii) a plurality of laterally-extending apertures formed in at least one marginal portion thereof that are axially spaced relative to each other and define laterally-extending segments therebetween that are adhesively attachable to a marginal portion of the mask defining the edge for adhesively attaching the tape to the mask.

2. A tape as defined in claim 1, wherein the edge covering portion and the marginal portions of the compressive layer are adhesive backed.

3. A tape as defined in claim 2, further comprising an adhesive layer underlying the compressive layer and substantially covering the respective side of the compressive layer.

4. A tape as defined in claim 3, wherein the adhesive layer extends across the laterally-extending apertures to thereby bond adjacent laterally-extending segments and prevent separation of the laterally-extending segments from each other without breaking the adhesive bond therebetween.

5. A tape as defined in claim 1, wherein the compressive layer defines a plurality of axially spaced, laterally-extending apertures formed in opposing marginal portions thereof.

6. A tape as defined in claim 5, wherein the opposing laterally-extending apertures are substantially aligned in opposing pairs of axially spaced, laterally-extending apertures.

7. A tape as defined in claim 5, wherein at least a plurality of the laterally-extending apertures are defined by slits.

8. A tape as defined in claim 1, wherein at least the edge covering portion of the compressive layer is formed of resilient material for cushioning the edge.

9. A tape as defined in claim 8, wherein the edge covering portion and opposing marginal portions are formed of resilient material.

10. A tape as defined in claim 9, wherein the compressive layer is formed of a foam.

11. A tape as defined in claim 1, wherein the compressive layer is a lamination defined by a plurality of layers.

12. A tape as defined in claim 1, wherein the compressive layer defines a thickness within the range of about 1/64 inch to about 1/16 inch and a width within the range of about ½ inch to about 1½ inch, the edge covering portion defines a width within the range of about 1/10 inch to about ⅖ inch, each laterally-extending aperture defines a length within the range of about ⅕ inch to about ⅘ inch, and adjacent laterally-extending apertures are axially spaced relative to each other a distance within the range of about 3/20 inch to about ⅗ inch.

13. A tape as defined in claim 1, wherein an exposed surface of the compressive layer defines is a durable marking surface for writing markings thereon in connection with a radiation treatment.

14. A tape as defined in claim 3, further comprising a manually-engageable liner releasably attached to the adhesive layer.

15. A tape as defined in claim 14, wherein the liner extends laterally beyond at least one marginal portion of the compressive layer.

16. A tape as defined in claim 15, wherein the liner extends laterally beyond opposing marginal portions of the compressive layer.

17. A tape as defined in claim 3, wherein the adhesive layer is a hypoallergenic, latex-free adhesive.

18. A tape as defined in claim 1, wherein each aperture is oriented substantially perpendicular to a respective side edge of the compressive layer.

19. A tape for attachment to a mask to cover an edge of the mask, comprising:
first means for substantially conformably covering the edge of the mask and providing a compressive surface to the edge;
a plurality of second means extending laterally from the first means and separable from each other for engaging at least one surface of the mask that is adjacent to the edge; and
third means for adhering at least one of the first and second means to the mask.

20. A tape as defined in claim 19, wherein the first means is an axially-extending edge covering portion of a compressive tape, each second means is a laterally extending segment formed between axially-spaced, laterally-extending apertures formed in a marginal portion of the tape, and the third means is an adhesive layer of the tape.

21. A tape as defined in claim 19, further comprising fourth means for releasably covering the third means.

22. A tape as defined in claim 21, wherein the fourth means is a release liner.

23. A tape as defined in claim 19, wherein the first and second means resiliently cover and cushion the edge and surface contiguous to the edge, respectively, of the mask.

24. A method comprising the following steps:
(i) substantially conformably covering an edge of a radiation therapy mask with an axially-extending, compressive edge covering portion of an adhesive-backed tape to cushion the edge and prevent the edge from harming a person using the mask; and
(ii) adhering a plurality of laterally-extending segments formed in at least one marginal portion of the adhesive-backed tape to at least one surface of the mask that is adjacent to the edge to substantially conformably attach the tape to the mask substantially throughout a respective radiation therapy treatment period.

25. A method as defined in claim 24, further comprising writing at least one marking on an exposed surface of the tape in connection with the radiation therapy treatment.

26. A method as defined in claim 24, wherein the adhering step includes folding a plurality of laterally-extending segments onto the surface of the mask adjacent to the edge, and during the step of folding pivoting adjacent laterally-extending segments at least one of (i) away from each other and (ii) into an overlapping relationship, to conformably attach the edge covering portion of the tape to the edge of the mask.
